(19) United States
(12) Patent Application Publication
(10) Pub. No.: US 2004/0237364 A1
(43) Pub. Date: Dec. 2, 2004

(54) Motion simulating lures and decoys

(76) Inventors: Brian Henry, Yuba City, CA (US); Dale Wilder, Yuba City, CA (US)

Correspondence Address: Andrew K. Youngs, P.O. Box 7179, Citrus Heights, CA, 95621, US

(21) Appl. No.: 10/453,134

(22) Filed: Jun. 2, 2003

(51) Int. Cl. G09F 13/22

(52) U.S. Cl. 40/544

(57) ABSTRACT

Lures and decoys for hunting and fishing have proven to be more effective when they are in motion, so as to appear more life-like to the prey. Historically, this motion has been provided by means of mechanical agitation of various sorts, which can be cumbersome and expensive to implement.

This novel method comprises the use of means by electronic, holographic lens or lenticular lens technology to economically and conveniently provide simulated motion of an item, typically a lure or decoy, whether the item is stationary or in physical motion. The use of holographic or lenticular lens technology allows the placement of a graphic onto the exterior of the object which will appear to change as the viewing angle of the viewer changes, thus simulating motion. The use of electronic means, via light-emitting diode (LED) or liquid crystal displays (LCD), can provide simulated motion via changes of display patterns over time.

In addition to providing motion simulation, this technique can be utilized to provide objects, such as lures and decoys, with a more natural or attracting appearance of motion than can be readily achieved by actual physical manipulation of the object, thus increasing their effectiveness. A great number of image patterns can be provided for each decoy, further improving the ability to simulate natural motion appearance.

### BACKGROUND OF THE INVENTION

Lures and decoys which are kept in physical motion have been found by sportsmen and researchers to be more effective in attracting target species than stationary lures and decoys. Prey is attracted to the lures or decoys when the lures or decoys are moving in the natural manner of the species being imitated by the lure or decoy. Simple attention getting is not sufficient; simulation of the natural movement of the species is necessary for optimum effectiveness.

Numerous patents have been issued on a variety of mechanical motion systems for waterfowl decoys, including Harrell (U.S. Pat. No. 6,412,210), Krag (U.S. Pat. No. 6,430,863), Solomon (U.S. Pat. No. 6,339,894), Brint, et. al. (U.S. Pat. No. 6,070,356), Okimoto (U.S. Pat. No. 5,926,990), and O'Neil (U.S. Pat. No. 4,535,560). In every case, these decoy systems provided a means of actual physical movement of the decoy or parts thereof to provide the mechanical motion required to increase waterfowl attraction to the decoys. These systems are generally relatively expensive or cumbersome if they produce sufficient motion to improve the attractive qualities of the decoy system over stationary decoys.

Fishing lures are designed to produce specific types of motion as they are pulled through the water. Dutcher, et. al. (U.S. Pat. No. 5,003,723) and Garratt (U.S. Pat. No. 6,349,498), for example, claim lures which are designed to produce a specific type of motion based on the mechanical configuration of the lure. Firmin (U.S. Pat. No. 4,069,610), creates the appearance of movement by providing a design wherein hollow projections on the lure release trapped air in the water, utilizing the bubbles released to physically move the lure as well as simulating motion by the motion of the air bubbles rising to the surface. Again, these lures rely on actual motion of some sort, either by a portion of the lure or by trapped air, to provide the attraction to the species.

Holographic and lenticular lens technology has been used by the printing and advertising industries to provide a novelty appearance to signs and printed materials, wherein the image changes as the viewer's angle of viewing changes. Sekiguchi, et. al. (U.S. Pat. No. 5,494,445 and U.S. Pat. No. 5,695,346) describe and claim a process and display with moveable images. These patents describe a system wherein lenticular lens technology is utilized to provide a display wherein there is the appearance of movement or change of the printed image as the angle of incidence of the viewer changes. The use of this technology to provide a simulation of the object to which it is attached is not discussed nor obvious from Sekiguchi.

Conley, et. al (U.S. Pat. No. 6,385,882) describes and claims a system whereby lenticular lens technology is used to make a two dimensional image appear to be three-dimensional. Conley also teaches that this technology makes the image appear to move within the stationary boundaries of the sign. Conley further states that the images can be used to attract the attention of animal as well as human viewers.

U.S. Pat. Nos. 5,494,445; 5,695,346; and 6,385,882 are incorporated by reference herein, and describe how lenticular lens technology is used to make changing images on a graphic. Changing pattern images with LED or LCD displays is also well known and easily constructed by those familiar with electronic displays.

Accordingly, there is a need for a decoy and lure system wherein the lure or decoy itself can be perceived by the prey as being in natural motion. There is also a need for a process of producing this without mechanical motion being required.

### BRIEF SUMMARY OF THE INVENTION

This invention comprises the use of either electronic, lenticular lens or holographic lens technologies, singly, pluraly or in combination, to produce the simulation of natural motion of a decoy, lure or other object to which it is attached. Prior art has utilized lenticular lens technology to simulate the movement of the printed image only. This method uses the apparent movement of the image to provide motion simulation for the entire object.

According to the present invention, these objects are achieved by utilizing at least two image patterns on an object or decal which is attached to the lure or decoy. The image patterns are manipulated to switch between patterns as the prey approaches. This switching can be done electronically, by the use of LED or LCD displays, or through the use of a lenticular or holographic lens, wherein the image seen changes as the angle of sight of the prey changes.

According to the present invention, an advantage of this system, in addition to the ability to simulate movement, the use of these changing images on a decoy or lure can provide a simulation of natural movement which does not rely on mechanical means.

A further aspect to this invention is that it is applicable to aspects of providing motion-simulating decoys beyond the field of hunting and fishing, and could be used in military or gaming applications.

### BRIEF DESCRIPTION OF THE FIGURES

FIG. 1 shows a duck wing decoy attachment showing the image displayed at acute viewing angles.

FIG. 2 is the duck wing decoy of FIG. 1 showing the image displayed at less acute angles.

FIG. 3 is a duck wing decoy attachment showing an example of a random pattern displayed at an acute viewing angle.

FIG. 4 is a duck wing decoy attachment showing an example of a random pattern displayed at a less acute angle.

FIG. 5 is a fishing lure showing the image displayed at acute viewing angles.

FIG. 6 is the fishing lure of FIG. 1 showing the image displayed at less acute angles.

FIG. 7 is an example of a type of attachment device which can be used to removeably attach the duck wing decoys to a decoy body.

FIG. 8 depicts an example of the changing viewing angles associated with FIGS. 1 and 2.

FIG. 9 depicts an example of the changing viewing angles associated with FIGS. 3 and 4.

### DETAILED DESCRIPTION OF THE INVENTION

Referring now to FIG. 1 and FIG. 2, this invention comprises the use of a changing pattern to attract the attention of prey species and lure them closer to the decoy. By providing a changing pattern simulating natural wing movement, the prey is more likely to approach the decoy than with fixed decoys. With the change in pattern appearance to the prey being an effect of viewing angle rather than mechanical motion on the part of the decoy apparatus, the decoy retains effectiveness while providing economy and ease of use for the user.

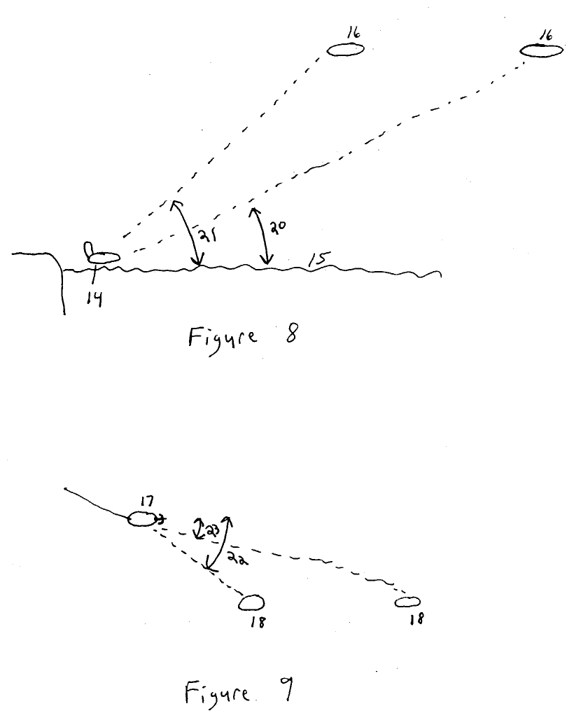

FIG. 1 depicts a duck wing decoy exhibiting an image approximating a folded wing pattern. It is to be understood that the size, shape, materials of construction and actual pattern of the decoy can vary from that shown and described. In the case of FIG. 1 duck wing decoy 1, in this example manufactured from molded plastic such as polyethylene, has been laminated with a series of lenticular lenses which provide for a change in image from that of FIG. 1 to that of FIG. 2 as the viewing angle of prey 16 towards decoy 14 changes from a more acute angle 20 to a less acute angle 21, as illustrated in FIG. 8.

The pattern in duck wing decoy 1 simulates a natural wing by providing contrasting areas illustrative of wing leading edge simulation 3, feather gap simulations 2 and feather body simulations 4. The location and appearance of these features change between FIG. 1 and FIG. 2 to simulate natural wing movement. It is understood that a large number of lenticular lenses may be utilized in a layered fashion to make the change in pattern effect continuous motion, and indeed the pattern may cycle back and forth several times between the patterns illustrated in FIGS. 1 and 2.

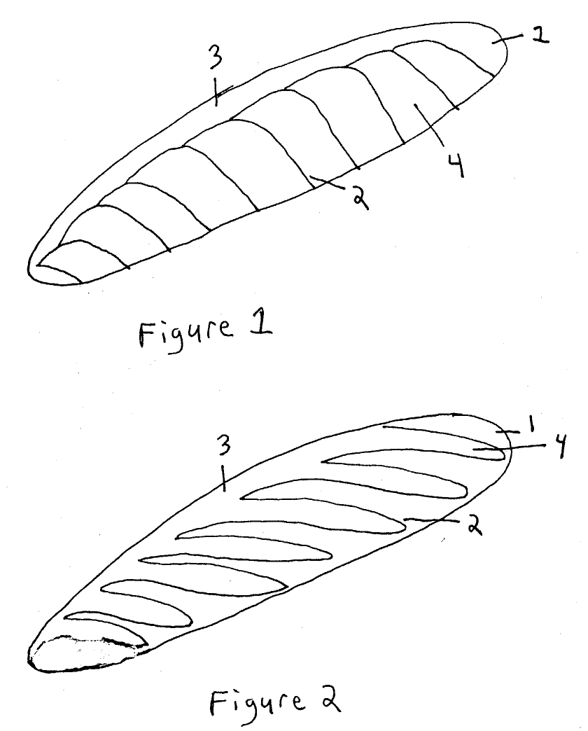

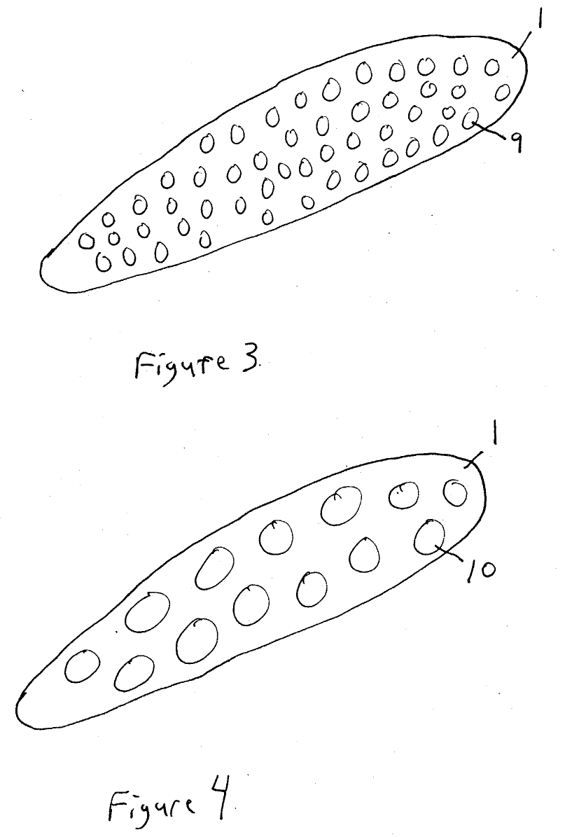

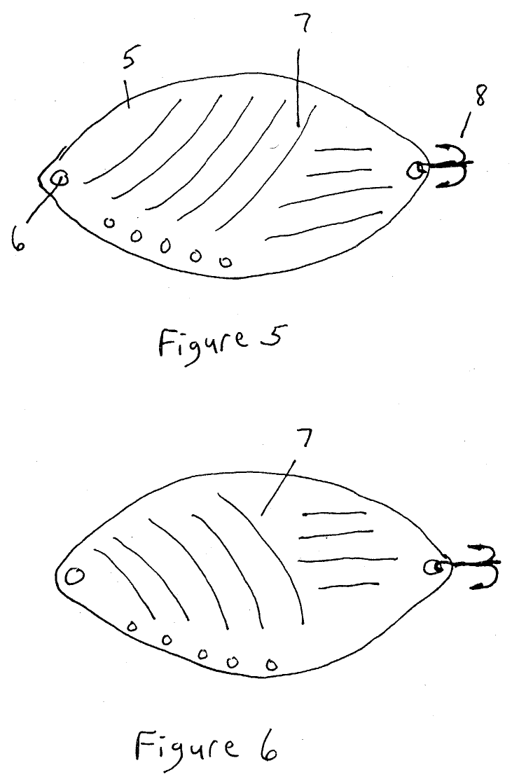

In one preferred embodiment of this invention, the patterns utilized simulate the pattern and look of a duck wing being lightly flapped as a duck would when settling down in the water. However, other patterns may be utilized, such as random patterns illustrated in FIGS. 3 and 4. FIG. 3 depicts a number of small circles 9 placed on duck wing decoy 1. As the viewing angle changes, the pattern of FIG. 3 is replaced with the pattern of FIG. 4, which is a number of much larger circles 10 also randomly placed. It is understood that the patterns may change in both size and shape in any manner desired.

The use of natural patterns as illustrated in FIGS. 1 and 2 provides an added benefit over the use of the random patterns of FIGS. 3 and 4 in that the natural movement patterns of the prey species may be depicted, thus enhancing the effectiveness of the decoy. However, the use of random patterns may prove more effective for some species of prey, or a combination of the use of natural movement patterns interspersed with decoys with random patterns changes.

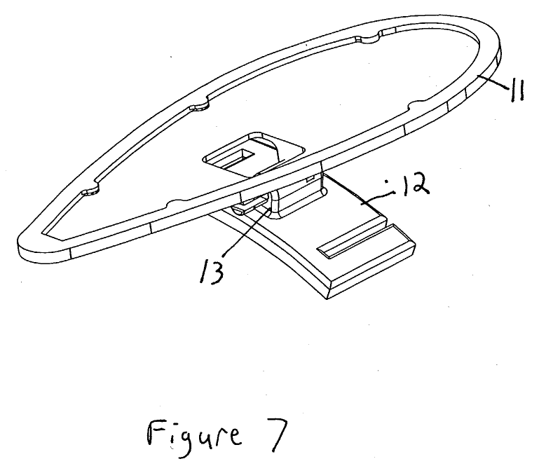

The use of changing patterns utilizing lenticular lens technology can be applied to other decoys, such as fishing lures. FIGS. 5 and 6 depict lure body 5 with hook 8 and pattern features 7, with the pattern features 7 changing as the viewing angles 22 and 23 toward lure 17 change as illustrated in FIG. 9. As with the duck wing decoys, the pattern features 7 can depict physical characteristics of bait species, and simulate natural motion, or can be a series of random patterns. In the case of a fishing lure, one advantage of the invention is that the lure can be stationary, and still simulate motion, thus saving the fisherman from having to cast and reel in the lure to attract the prey.

In addition to the use of lenticular lens technology, the patterns and images described herein can also be produced electronically through the use of light emitting diode (LED) arrays and liquid crystal (LCD) displays. Although LED traditionally suffer from fairly intensive power requirements, and LCDs from problems with visibility from a variety of angles and lighting conditions, the use of such devices is considered a portion of this invention.

FIG. 7 illustrates how, in one preferred embodiment, the duck wing decoy 1 can be attached to a frame 11 which is attached thru pivoting column 13 to slotted attachment plate 12. The slot in plate 12 can slide onto a raised area on a decoy body to provide a means for removeably attaching the duck wing decoy assembly to the decoy body. Alternate techniques for attaching the decoy patterns could include but are not limited to adhesive or Velcro attachment, as well as laminating the lenticular lens assembly directly to the decoy body.

There are a number of materials and material combinations which can be utilized as the structural portion of the decoy and the lens material, including a variety of plastics and metals.

The current invention is most commonly expected to be applied to hunting decoys and fishing lures, but is applicable to any scenario wherein simulated motion, particularly simulated natural motion, is required, not just the uses shown and described. Note that fishing lures are essentially fish decoys with a catching means attached, such as a hook, and that the embodiments of the invention apply equally well to lures as a subset of the broader category of decoys. For purposes of this application, the term decoy is expressly considered to include the category of lures and baits such as fishing lures.

We claim:

1. A decoy system comprising;
a decoy;
a graphic attached to the decoy;
means for providing multiple images from the graphic, said images changing based on time passage or viewing angle.

2. The decoy system according to claim 1 wherein the graphic images change based on viewing angle due to the use of a lenticular lens.

3. The decoy system according to claim 1 wherein the graphic images change based on viewing angle due to the use of a holographic lens.

4. The decoy system of claim 1 wherein the graphic images change over time due to the use of a changing electronic display, said display comprising a set of light-emitting diodes or a liquid crystal display.

5. The decoy system of claim 1, 2, 3 or 4 wherein the image pattern simulates a natural movement of the species the decoy emulates.
